(19) United States
(12) Patent Application Publication
(10) Pub. No.: US 2025/0012191 A1
(43) Pub. Date: Jan. 9, 2025

(54) TURBINE BLADE UNDER-PLATFORM STRUCTURE AND POCKET

(71) Applicant: GE Infrastructure Technology, LLC, Greenville, SC (US)

(72) Inventors: Zachary John Snider, Pelzer, SC (US); Brandon Lee Cox, Greenville, SC (US)

(21) Appl. No.: 18/219,179

(22) Filed: Jul. 7, 2023

(51) Int. Cl. F01D 5/08; F01D 5/30

(52) U.S. Cl. CPC F01D 5/147; F01D 5/187; F05D 2240/81

(57) ABSTRACT

A turbine blade includes a root with a shank having a buttress extending from the shank bottom to an end of a turbine blade platform. The buttress provides increased structural integrity for a given shank mass, allowing mass reduction. With a shank wall and bottom of the platform, the buttress defines a pocket below the platform that can be part of a cooling circuit of the blade. The pocket can be on a suction side or pressure side of the root and can include portions or pockets on both sides of the root that can be in fluid communication with one another.

### TECHNICAL FIELD

The disclosure relates generally to a gas turbine system and, more particularly, to a blade including under-platform features simultaneously reducing mass and enhancing performance.

### BACKGROUND

Rotating blades in turbomachines, particularly those in the hot gas paths of turbines, operate at extremely high temperatures under high loads in multiple axes. Consequently, such blades must be made from materials with high melting points that can also withstand the loads to which the blades are subjected. Such materials are expensive, and so there is a need for blade designs that can perform as needed with as little material as possible.

### BRIEF DESCRIPTION

All aspects, examples, and features mentioned below can be combined in any technically possible way.

The present disclosure provides a turbine blade that includes a root with a shank having a buttress extending from the shank bottom to an end of a turbine blade platform. The buttress provides increased structural integrity for a given shank mass, allowing mass reduction. With a shank wall and bottom of the platform, the buttress defines a pocket below the platform that can be part of a cooling circuit of the blade. The pocket can be on a suction side or pressure side of the root and can include portions or pockets on both sides of the root that can be in fluid communication with one another.

More specifically, an aspect of the disclosure provides a turbine blade, comprising an airfoil including a tip, a body, and a base; a platform connected to the base of the airfoil; and a shank extending from the platform to a dovetail, the shank including: forward and aft walls below and connected to corresponding forward and aft ends of the platform; and a first buttress disposed between the forward and aft walls on one of a suction side of the shank and a pressure side of the shank, wherein the first buttress extends from a lower portion of the shank to a corresponding end of the platform, and a first portion of the first buttress is oriented at an angle of at least 30° with a first inner wall of the shank, defining a first pocket between at least the first buttress and the first inner wall.

Another aspect of the disclosure includes any of the preceding aspects, and wherein the first pocket is further defined by a bottom of the platform.

Another aspect of the disclosure includes any of the preceding aspects, and wherein the first pocket is further defined by at least one of the forward wall and the aft wall.

Another aspect of the disclosure includes any of the preceding aspects, and wherein a second portion of the first buttress is oriented at an angle of at least 30° with the at least one of the forward wall and the aft wall.

Another aspect of the disclosure includes any of the preceding aspects, and wherein a distance between the first inner wall and the first buttress varies between the forward and aft walls.

Another aspect of the disclosure includes any of the preceding aspects, and wherein the distance between the first inner wall and the first buttress changes with distance from the platform.

Another aspect of the disclosure includes any of the preceding aspects, and further comprising a second buttress disposed between the forward and aft walls on the other of the suction side of the shank and the pressure side of the shank, wherein the second buttress extends from the lower portion of the shank to a corresponding end of the platform, and a first portion of the second buttress is oriented at an angle of at least 30° with a second inner wall of the shank, defining a second pocket between at least the second buttress and the second inner wall.

Another aspect of the disclosure includes any of the preceding aspects, and wherein the first pocket is in fluid communication with the second pocket.

Another aspect of the disclosure includes any of the preceding aspects, and wherein at least one of the first pocket and the second pocket is in fluid communication with a cooling circuit of the turbine blade.

An aspect of the disclosure provides a gas turbine system, comprising a turbine section including a hot gas flow path; a plurality of circumferentially spaced turbine blades in the turbine section extending radially from a rotor of the turbine and into the hot gas flow path, each turbine blade including: a root including a shank and a dovetail, the dovetail being mounted to the rotor; a platform connected to the shank; an airfoil supported by the platform and extending radially away from the platform; and wherein the shank includes: forward and aft walls below and connected to corresponding forward and aft ends of the platform; and a first buttress disposed between the forward and aft walls on one of a suction side of the shank and a pressure side of the shank, wherein the first buttress extends from a lower portion of the shank to a corresponding end of the platform, and a first portion of the first buttress is oriented at an angle of at least 30° with a first inner wall of the shank, defining a first pocket between at least the first buttress and the first inner wall.

Another aspect of the disclosure includes any of the preceding aspects, and wherein the first pocket is further defined by a bottom of the platform.

Another aspect of the disclosure includes any of the preceding aspects, and wherein the first pocket is further defined by at least one of the forward wall and the aft wall.

Another aspect of the disclosure includes any of the preceding aspects, and wherein a second portion of the first buttress is oriented at an angle of at least 30° with the at least one of the forward wall and the aft wall.

Another aspect of the disclosure includes any of the preceding aspects, and wherein a distance between the first inner wall and the first buttress varies between the platform and the dovetail.

Another aspect of the disclosure includes any of the preceding aspects, and wherein the distance between the first inner wall of the shank and the first buttress changes with distance from the platform.

Another aspect of the disclosure includes any of the preceding aspects, and wherein the shank further comprises a second buttress disposed between the forward and aft walls on the other of the suction side of the shank and the pressure side of the shank, wherein the second buttress extends from the lower portion of the shank to a corresponding end of the platform, and a first portion of the second buttress is oriented at an angle of at least 30° with a second inner wall of the shank, defining a second pocket between at least the second buttress and the second inner wall.

Another aspect of the disclosure includes any of the preceding aspects, and wherein at least one of the first pocket and the second pocket is in fluid communication with a cooling circuit of the turbine blade.

An aspect of the disclosure provides a turbine blade comprising: an airfoil including a tip, a body, and a base; a platform connected to the base of the airfoil; a root including a shank and a dovetail, the shank extending from the platform to the dovetail, the shank further including forward and aft walls below and connected to respective ends of the platform, and first and second inner walls on respective suction and pressure sides of the shank, wherein a cross-sectional profile of the shank in a plane parallel to the platform includes an inner portion that includes the first and second inner walls; and wherein the shank further includes first and second buttresses on the suction and pressure sides of the shank, respectively, each of the first and second buttresses extending from a lower portion of the shank away from the respective first and second inner walls to corresponding ends of the platform, at least the first and second buttresses together with the respective first and second inner walls and a bottom of the platform defining respective first and second pockets below the platform.

Another aspect of the disclosure includes any of the preceding aspects, and wherein a first portion of each of the first and second buttresses are oriented at respective angles of at least 30° with the first and second inner walls, respectively.

Another aspect of the disclosure includes any of the preceding aspects, and wherein at least one of the first and second pockets is in fluid communication with a cooling circuit of the turbine blade.

Two or more aspects described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of an illustrative turbomachine in the form of a gas turbine system;

FIG. 2 shows a cross-sectional view of an illustrative turbine assembly that may be used with the gas turbine system in FIG. 1;

FIG. 3 shows a perspective view of a turbine rotating blade of the type in which embodiments of the disclosure may be employed;

FIG. 4 shows a partially cross-sectional, side view of an illustrative blade showing a pocket formed on a suction side of the blade, according to embodiments of the disclosure;

FIG. 5 shows a partially cross-sectional, side view of the illustrative showing a pocket formed on a pressure side of the blade, according to embodiments of the disclosure;

FIG. 6 shows a cross-sectional view taken along line A-A in FIGS. 4 and 5, according to embodiments of the disclosure;

FIG. 7 shows a cross-sectional view taken along line B-B in FIGS. 4 and 5, according to embodiments of the disclosure;

FIG. 8 shows a cross-sectional view taken along line C-C in FIGS. 4 and 5, according to embodiments of the disclosure;

FIG. 9 shows a cross-sectional view taken along line D-D in FIGS. 4 and 5, according to embodiments of the disclosure;

FIG. 10 shows a partially cross-sectional, perspective view of an illustrative blade showing pockets similar to that of FIG. 7 and including elements of a cooling circuit, according to embodiments of the disclosure;

FIG. 11 shows an enlarged partially cross-sectional, perspective view of an illustrative blade similar to that of FIG. 10 and including elements of a cooling circuit, according to other embodiments of the disclosure; and

FIG. 12 shows an enlarged partially cross-sectional, perspective view of an illustrative blade similar to that of FIG. 10 and including elements of a cooling circuit, according to yet other embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant machine components within the illustrative application of a turbine blade with structural and thermal management features below its platform. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbomachine or, for example, the flow of air through the combustor or coolant through one of the turbomachine's component systems. The term “downstream” corresponds to the direction of flow of the fluid, and the term “upstream” refers to the direction opposite to the flow. The terms “forward” and “aft,” without any further specificity, refer to directions, with “forward” or “fore” referring to the front or compressor end of the turbomachine, and “aftward” or “aft” referring to the rearward or turbine end of the turbomachine.

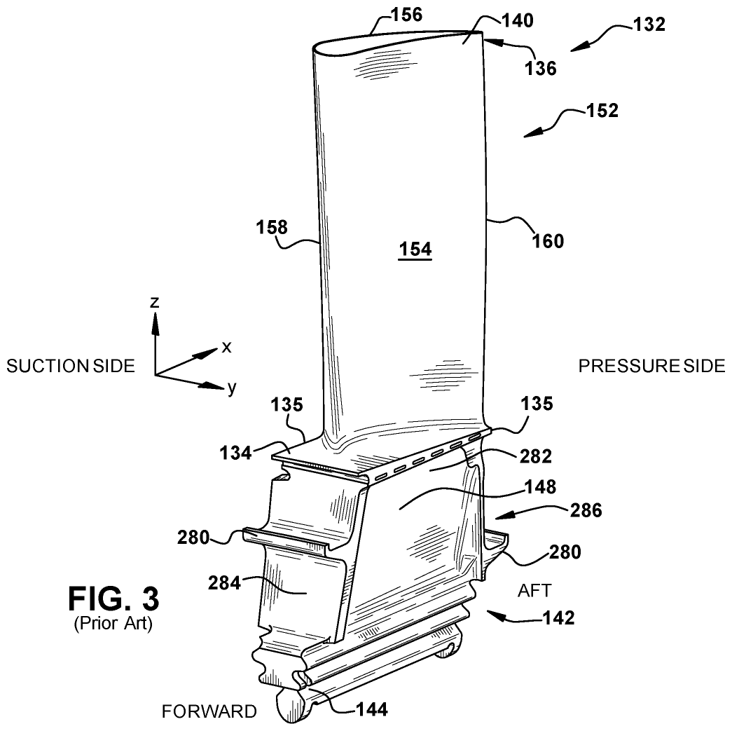

It is often required to describe parts that are at different radial positions with regard to a center axis. The term “axial” refers to movement or position parallel to an axis, e.g., an axis of a turbomachine (indicated by “X” direction arrow in FIG. 3). The term “radial” refers to movement or position perpendicular to an axis, e.g., an axis of a turbomachine (indicated by “Z” direction arrow in FIG. 3). In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a casing extending about an axis of a turbomachine (indicated by “Y” direction arrow in FIG. 3). As indicated above, it will be appreciated that such terms may be applied in relation to the axis of the turbomachine or, on a component scale, to a centerline axis of an individual turbomachine component (e.g., a rotating blade).

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present and that the description includes instances where the event occurs or the component is present and instances where the event does not occur or the component is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

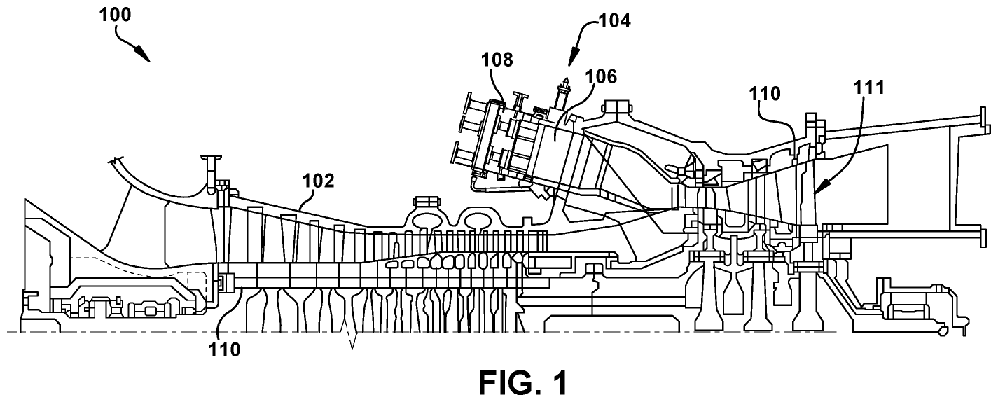

FIG. 1 shows a schematic illustration of an exemplary turbomachine. In the example, a turbomachine 100 is in the form of a combustion or gas turbine system. Turbomachine 100 includes a compressor 102 and a combustor 104. Combustor 104 includes a combustion region 106 and a fuel nozzle assembly 108. Turbomachine 100 also includes a turbine assembly 110 (e.g., an expansion turbine) and a common compressor/turbine shaft 112 (sometimes referred to as a rotor 112). In one embodiment, turbomachine 100 is a 7HA.03 engine, commercially available from General Electric Company, Greenville, S.C. The present disclosure is not limited to any one particular GT system and may be implanted in connection with other engines including, for example, the other HA, F, B, LM, GT, TM and E-class engine models of General Electric Company, and engine models of other companies. The present disclosure is not limited to any particular turbine or turbomachine and may be applicable to, for example, steam turbines, jet engines, compressors, turbofans, etc. Furthermore, the present disclosure is not limited to any particular turbomachine and may be applied to any form of component exposed to a hot gas path and requiring cooling and stress relief.

In operation, air flows through compressor 102, and compressed air is supplied to combustor 104. Specifically, the compressed air is supplied to fuel nozzle assembly 108 that is integral to combustor 104. Assembly 108 is in flow communication with combustion region 106. Fuel nozzle assembly 108 is also in flow communication with a fuel source (not shown) and channels fuel and air to combustion region 106. Combustor 104 ignites and combusts fuel to produce a hot gas stream. Combustor 104 is in flow communication with turbine assembly 110 within which gas stream thermal energy is converted to mechanical rotational energy. Turbine assembly 110 includes a turbine 111 that rotatably couples to and drives rotor 112. Compressor 102 also is rotatably coupled to rotor 112. In the illustrative embodiment, there is a plurality of combustors 104 and fuel nozzle assemblies 108.

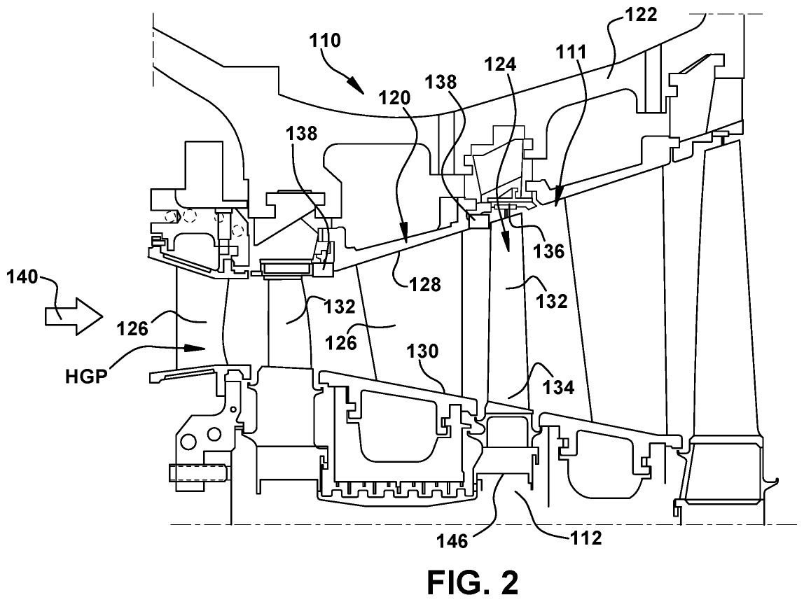

FIG. 2 shows a cross-sectional view of an illustrative turbine assembly 110 of turbomachine 100 (FIG. 1) that may be used with the gas turbine system in FIG. 1. As illustrated, turbine 111 of turbine assembly 110 includes three turbine stages, each including a row 120 of nozzles 126 coupled to a stationary casing 122 of turbomachine 100 (FIG. 1) and an axially adjacent a row 124 of rotating blades 132. A nozzle 126 (also known as a vane) may be held in turbine assembly 110 by a radially outer platform 128 and a radially inner platform 130. Each stage of blades 124 in turbine assembly 110 includes rotating blades 132 coupled to rotor 112 and rotating with the rotor. Rotating blades 132 may include a radially inner platform 134 (at root of blade) coupled to rotor 112 and a radially outer tip 136 (at tip of blade). Shrouds 138 may separate adjacent stages of nozzles 126 and rotating blades 132. In some turbine assemblies 110, four turbine stages may be used.

A working fluid 140, including for example combustion gases in the example gas turbine, passes through turbine 111 along what is referred to as a hot gas path (hereafter simply “HGP”). The HGP can be any area of turbine 111 exposed to hot temperatures. Parts of turbine 111 or other machine exposed to the HGP are referred to as “HGP components.” In the turbine 111, nozzles 126, blades 132, and shrouds 138 are exemplary HGP components. In the example turbine 111, blades 132 may benefit from the teachings of the disclosure.

FIG. 3 shows a perspective view of a turbine rotating blade 132 of the type in which embodiments of the disclosure may be employed. Turbine rotating blade 132 includes a root 142 by which rotating blade 132 attaches to rotor 112 (FIG. 2). Root 142 may include a dovetail 144 configured for mounting in a corresponding dovetail slot in the perimeter of a rotor wheel 146 (FIG. 2) of rotor 112 (FIG. 2). Root 142 may further include a shank 148 that extends between dovetail 144 and platform 134. Platform 134 is disposed at the junction of airfoil 152 and root 142 and defines a portion of the inboard boundary of the HGP through turbine assembly 110 (FIG. 2). It will be appreciated that airfoil 152 is the active component of rotating blade 132 that intercepts the flow of working fluid and induces the rotor wheel to rotate. It will be seen that airfoil 152 of rotating blade 132 includes a concave pressure side (PS) outer wall 154 and a circumferentially or laterally opposite convex suction side (SS) outer wall 156 extending axially between opposite leading and trailing edges 158, 160 respectively. Side walls 154 and 156 also extend in the radial direction from platform 134 to radial outer tip 136. Tip 136 may include any now known or later developed tip (e.g., with or without a tip shroud).

A cooling circuit can be used, for example, within airfoil 152, platform 134 or other parts of rotating blade 132. For example, cooling passages (not numbered) can be formed in platform 134 with openings in slash faces 135. Seal rails 280 can extend from forward and aft walls 284, 286 of shank 148 that extend from and are connected to corresponding ends of platform 134. Forward wall 284 of shank is located radially inward of forward end of platform 134 and leading edge 158 of airfoil 152. Aft wall 286 is located radially inward of aft end of platform 134 and trailing edge 160 of airfoil 152.

To provide a rotating blade for a turbomachine that possesses required strength with less added mass than using traditional techniques, embodiments include a wall formed to extend from a lower portion of a side of a blade shank to an end of a blade platform. The wall is referred to herein as a “buttress” in part due to its resemblance to architectural buttresses when viewed in cross section. A buttress can be formed on one or both of a suction side and a pressure side of the shank, so that a pocket is defined on each side by the new buttresses, the existing interior shank walls, and the platform. Aft and forward walls of the shank can also define the pocket(s). The resulting pocket(s) can advantageously be used in cooling circuits and the like while the buttresses provide structural and thermal performance enhancements with relatively little added material and associated mass.

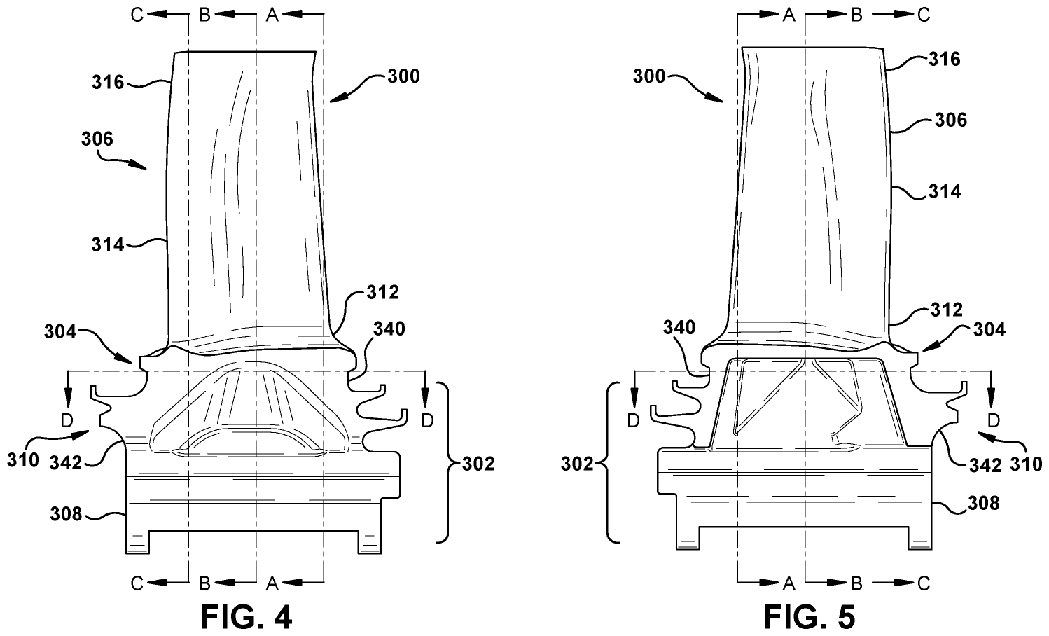

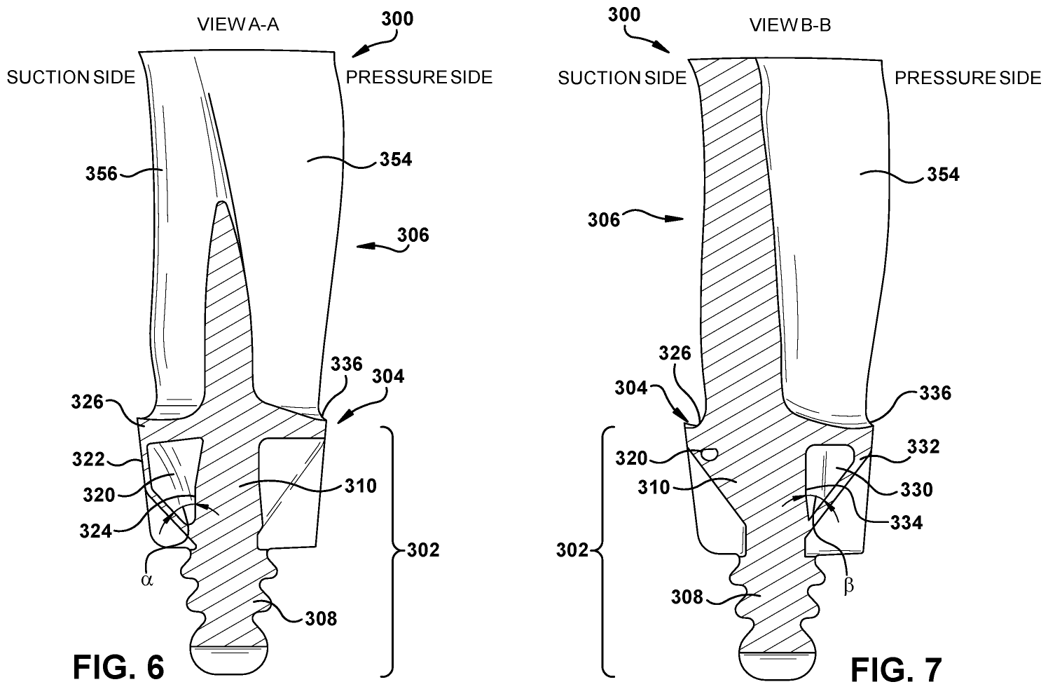

FIG. 4 shows a partially cross-sectional, side view of a suction side of a blade 300, such as a turbine blade, and FIG. 5 shows a partially cross-sectional, side view of a pressure side view of blade 300. Hence, FIGS. 4 and 5 show opposite sides of blade 300. View lines A-A, B-B, C-C, and D-D shown in FIGS. 4 and 5 are used to take sections of blade 300 shown in FIGS. 6-9, respectively.

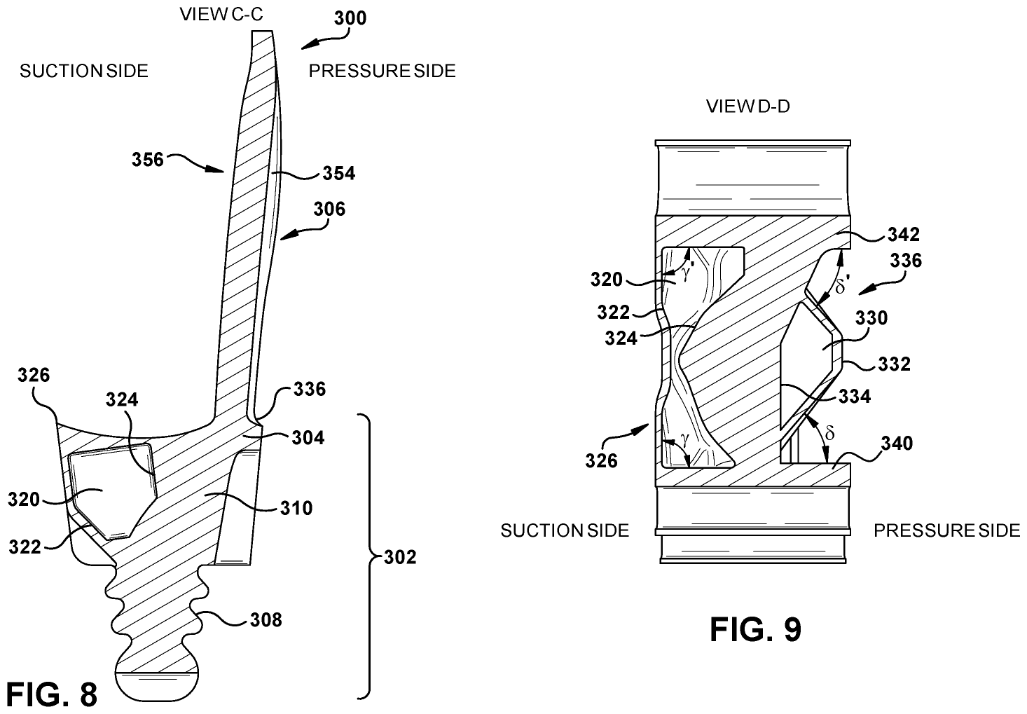

Turning now to FIGS. 4-9, blade 300 can include a root 302, a platform 304, and an airfoil 306. Root 300 can include a dovetail 308 and a shank 310 extending between dovetail 308 and platform 304. Platform 304 can be connected to a base 312 of airfoil 306 and can support airfoil 306. A body 314 of airfoil 306 extends toward a tip 316 of airfoil 306. As seen in lower portions of FIGS. 6-8 and in FIG. 9, one or more pockets 320, 330 can be partially defined by walls of root 302 and platform 304 as will be described. As discussed above with reference to blade 132, body 314 of airfoil 306 has a concave pressure side 354 and a convex suction side 356. In addition, blade 300 has aft and forward ends or sides as illustrated in FIGS. 4 and 5. For convenience, elements will be referred to as being on or having a pressure side or end, a suction side or end, an aft end or side, and a forward end or side.

Turning now to FIGS. 6-9, a pocket 320, 330 can be defined by at least a buttress 322, 332 of shank 310 and an inner wall 324, 334 of shank 310. Buttress 322, 332 in embodiments extends from a lower portion of shank 310 to a corresponding end 326, 336 of platform 304 and provides additional structural integrity for shank 310 and root 302 overall. The presence of buttress 322, 332 allows use of a reduced mass shank 310 that still meets design criteria. In addition, pocket 320, 330 can further be defined by a bottom of platform 304, as well as by a forward wall 340 and/or an aft wall 342 of shank 310. In embodiments, pocket 320, 330 can be part of and/or in fluid communication with a cooling circuit of blade as will be described.

As particularly seen in FIGS. 6-8, a first pocket 320 can be located on a suction side of root 302 and can be defined by at least a suction side or first buttress 322 of shank 310 and a suction side or first inner wall 324 of shank 310. For example, suction side or first buttress 322 can extend from a lower portion of shank 310 away from suction side or first inner wall 324 and to a corresponding end 326 on the suction side of platform 304. Suction side or first buttress 322 can include a first portion that couples to shank 310 adjacent to dovetail 308. At least the first portion of first buttress 322 can form an angle α of at least 30° with first inner wall 324. In addition, as particularly seen in FIG. 9, at least a second portion of first buttress 322 (proximate to platform 304) can form an angle γ, γ′ of at least 30° with one or both of forward and aft walls 340, 342 of shank 310.

Alternatively, or in addition to first pocket 320, a second pocket 330 can be formed on a pressure side of root 302 and can be defined by at least a pressure side or second buttress 332 and a pressure side or second inner wall 334 of shank 310. For example, pressure side or second buttress 332 can extend from a lower portion of shank 310 away from pressure side or second inner wall 334 and to a corresponding end 336 on the pressure side of platform 304. Pressure side of second buttress 332 can include a first portion that couples to shank 310 adjacent to dovetail 308. At least the first portion of second buttress 332 can form an angle β of at least 30° with second inner wall 334. In addition, as particularly seen in FIG. 9, at least a second portion of second buttress 332 (proximate to platform 304) can form an angle δ, δ′ of at least 30° with one or both of forward and aft walls 340, 342 of shank 310.

While the example shown in the Figures includes two pockets that are referred to as “first” and “second” pockets, it should be understood that embodiments can use only one pocket where suitable and/or desired. In embodiments, first pocket 320 can be in fluid communication with second pocket 330. In addition, while one pocket could be one of first and second pockets 320, 330, in some embodiments, first pocket 320 can be a first pocket portion on a suction side of the root, second pocket 330 can be a second pocket portion on a pressure side of the root, and the first pocket portion can be in fluid communication with the second pocket portion so that what are shown as first and second pockets 320, 330 can effectively form a single pocket under platform 304 in root 302 of blade 300.

As also seen in FIGS. 4-9, shank 310 varies in size, location, and shape in multiple dimensions. For example, as shown in FIG. 9, a cross sectional profile of shank 310 in a plane parallel to platform 304 can show a solid portion defined by first and second inner walls 324, 334 with first and second pockets 320, 330 between first and second inner walls 324, 334 and first and second buttresses 322, 332. As particularly seen in FIG. 9, but also suggested by FIGS. 6-8, the inner, solid portion of shank 310 varies with the footprint of shank 310 (that is, between platform 304 and dovetail 308). In addition, the cross sectional profile of shank 310 varies with distance from platform 304, with tendency toward decreasing width farther from platform 304.

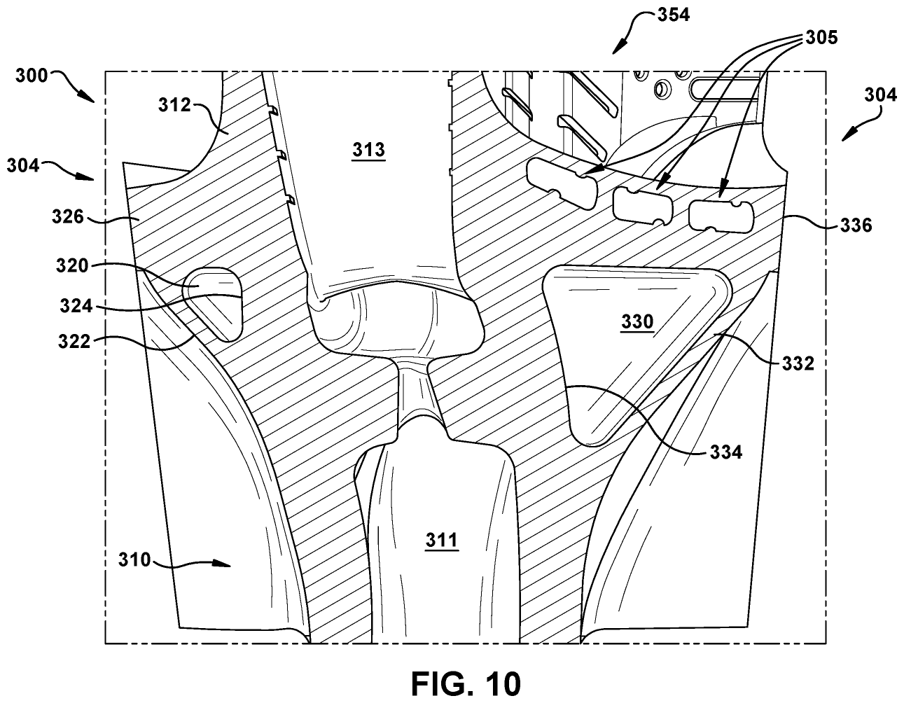

FIG. 10 shows a partially cross-sectional, perspective view of blade 300 illustrating open areas of an illustrative blade similar to that of FIG. 7 and including elements of one or more cooling circuits. In FIG. 10, a cooling circuit of blade 300 can include a root passage 311 in fluid communication with an airfoil passage 313. Additionally, platform 304 can include a serpentine cooling passage 305 that could be in fluid communication with the cooling circuit that includes root passage 311 and airfoil passage 313, or could be part of a different cooling circuit. FIG. 10 illustrates first and second pockets 320, 330 in a blade 300 including such a cooling circuit(s), but here first and second pockets 320, 330 are not in fluid communication with the cooling circuit(s).

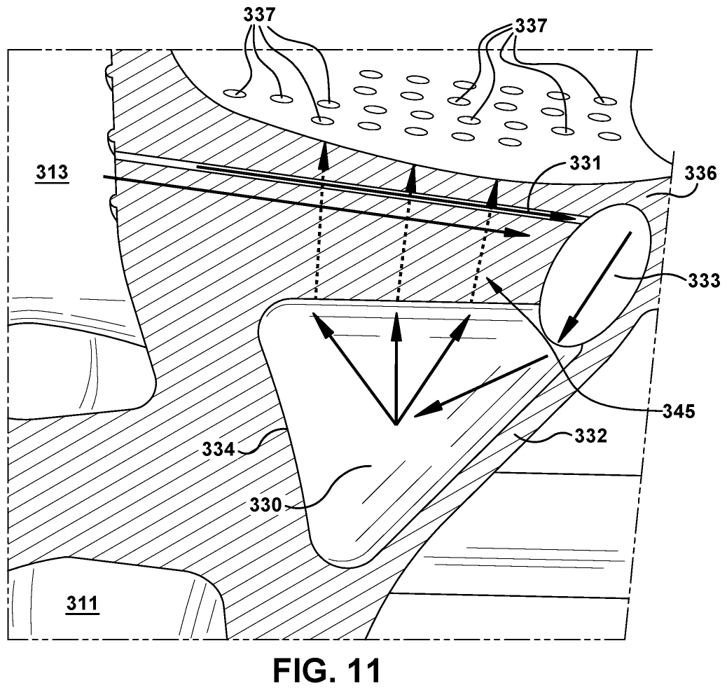

FIG. 11 illustrates a non-limiting example of providing fluid communication between a cooling circuit of blade 300 and second pocket 330. More specifically, a platform conduit 331 can extend from airfoil passage 313 to a plenum 333, which is fluidly coupled to second pocket 330. Second pocket 330 can receive coolant entering from airfoil passage 313 and plenum 333 and distribute such coolant to cooling holes 337 in a surface of platform 304, such as via passages 345 represented by dashed arrows extending from second pocket 330 to cooling holes 337 in the surface of platform 304.

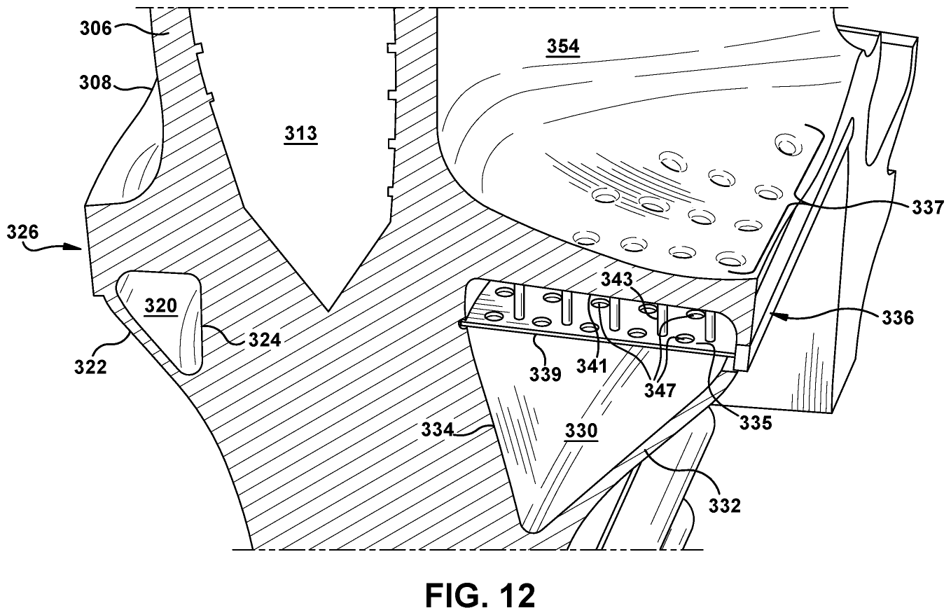

Another non-limiting example is seen in FIG. 12, in which a platform chamber 335 can be included to, for example, provide impingement cooling of platform 304 and/or to aid in distribution of coolant from second pocket 330 to cooling holes 337. For example, an intermediate wall 339 can be formed within second pocket 330 spaced apart from a bottom surface 341 of platform 304 to define platform chamber 335. Coolant supplied to second pocket 330 (e.g., by a passage, not shown, coupled to root passage 311 or airfoil passage 313) can pass through impingement holes 347 into platform chamber 335 and can strike bottom surface 341 of platform 304 to provide impingement cooling of platform 304. Coolant can then exit platform chamber 335 via cooling holes 337, which can extend from bottom surface 341 of platform 304 to a top surface of platform 304 to further cool platform 304. To strengthen intermediate wall 339, support members 343, such as pins, can extend between intermediate wall 339 and bottom surface 341 of platform 304. While the examples illustrated in FIGS. 11 and 12 depict second pocket 330 as part of and/or in fluid communication with a cooling circuit of blade 300, it should be understood that similar connections could be made to first pocket 320 instead of or in addition to those made to second pocket 330 if desired and/or appropriate in embodiments.

Embodiments can include, for example, deploying blade 300 in a gas turbine system, such as the turbomachine 100 shown in FIGS. 1 and 2. Thus, embodiments can include a gas turbine system 100 with a turbine assembly 110 including a hot gas flow path HGP (FIG. 2). With reference to FIG. 2, a plurality of circumferentially spaced rotating blades 132, such as blades 300, in turbine assembly 110 can extend radially from a rotor 112 of turbine 111 in turbine assembly 110 and into the hot gas flow path HGP. Each blade 300 can include features described above with reference to FIGS. 4-12, above, and as described herein.

Embodiments of the disclosure provide various technical and commercial advantages, examples of which are discussed herein. In particular, by forming a buttress on one or both of the suction and pressure sides of a blade root as described above, structural integrity of the blade can be bolstered while adding less mass to the blade than using prior art techniques. The buttress(es) can define one or more pockets below a blade platform that can advantageously be used in a cooling circuit of the blade or in other systems in which the pocket(s) could be beneficially employed to enhance performance of a turbomachine, such as a gas turbine system, in which the blade is employed.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate+/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and explanation but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of such technology and to enable others of ordinary skill in the art to understand the various embodiments of the present disclosure and the possibility of various modifications of the disclosed embodiments, as may be suited to the particular use(s) contemplated.

1. A turbine blade comprising:
an airfoil including a tip, a body, and a base;
a platform connected to the base of the airfoil; and
a shank extending from the platform to a dovetail, the shank including:
forward and aft walls below and connected to corresponding forward and aft ends of the platform; and
a first buttress disposed between the forward and aft walls on one of a suction side of the shank and a pressure side of the shank, wherein the first buttress extends from a lower portion of the shank to a corresponding end of the platform, and a first portion of the first buttress is oriented at an angle of at least 30° with a first inner wall of the shank, defining a first pocket between at least the first buttress and the first inner wall.

2. The turbine blade of claim 1, wherein the first pocket is further defined by a bottom of the platform.

3. The turbine blade of claim 1, wherein the first pocket is further defined by at least one of the forward wall and the aft wall.

4. The turbine blade of claim 3, wherein a second portion of the first buttress is oriented at an angle of at least 30° with the at least one of the forward wall and the aft wall.

5. The turbine blade of claim 1, wherein a distance between the first inner wall and the first buttress varies between the platform and the dovetail.

6. The turbine blade of claim 5, wherein the distance between the first inner wall and the first buttress changes with distance from the platform.

7. The turbine blade of claim 1, further comprising a second buttress disposed between the forward and aft walls on the other of the suction side of the shank and the pressure side of the shank, wherein the second buttress extends from the lower portion of the shank to a corresponding end of the platform, and a first portion of the second buttress is oriented at an angle of at least 30° with a second inner wall of the shank, defining a second pocket between at least the second buttress and the second inner wall.

8. The turbine blade of claim 7, wherein the first pocket is in fluid communication with the second pocket.

9. The turbine blade of claim 7, wherein at least one of the first pocket and the second pocket is in fluid communication with a cooling circuit of the turbine blade.

10. A gas turbine system, comprising:
a turbine section including a hot gas flow path; and
a plurality of circumferentially spaced turbine blades in the turbine section extending radially from a rotor of the turbine and into the hot gas flow path, each turbine blade including:
a root including a shank and a dovetail, the dovetail being mounted to the rotor;
a platform connected to the shank;
an airfoil supported by the platform and extending radially away from the platform; and
wherein the shank includes:
forward and aft walls below and connected to corresponding forward and aft ends of the platform; and
a first buttress disposed between the forward and aft walls on one of a suction side of the shank and a pressure side of the shank, wherein the first buttress extends from a lower portion of the shank to a corresponding end of the platform, and a first portion of the first buttress is oriented at an angle of at least 30° with a first inner wall of the shank, defining a first pocket between at least the first buttress and the first inner wall.

11. The gas turbine system of claim 10, wherein the first pocket is further defined by a bottom of the platform.

12. The gas turbine system of claim 10, wherein the first pocket is further defined by at least one of the forward wall and the aft wall.

13. The gas turbine system of claim 12, wherein a second portion of the first buttress is oriented at an angle of at least 30° with the at least one of the forward wall and the aft wall.

14. The gas turbine system of claim 10, wherein a distance between the first inner wall and the first buttress varies between the platform and the dovetail.

15. The gas turbine system of claim 14, wherein the distance between the first inner wall of the shank and the first buttress changes with distance from the platform.

16. The gas turbine system of claim 10, wherein the shank further comprises a second buttress disposed between the forward and aft walls on the other of the suction side of the shank and the pressure side of the shank, wherein the second buttress extends from the lower portion of the shank to a corresponding end of the platform, and a first portion of the second buttress is oriented at an angle of at least 30° with a second inner wall of the shank, defining a second pocket between at least the second buttress and the second inner wall.

17. The gas turbine system of claim 16, wherein at least one of the first pocket and the second pocket is in fluid communication with a cooling circuit of the turbine blade.

18. A turbine blade comprising:
an airfoil including a tip, a body, and a base;
a platform connected to the base of the airfoil;
a root including a shank and a dovetail, the shank extending from the platform to the dovetail, the shank further including forward and aft walls below and connected to respective ends of the platform, and first and second inner walls on respective suction and pressure sides of the shank, wherein a cross-sectional profile of the shank in a plane parallel to the platform includes an inner portion that includes the first and second inner walls; and
wherein the shank further includes first and second buttresses on the suction and pressure sides of the shank, respectively, each of the first and second buttresses extending from a lower portion of the shank away from the respective first and second inner walls to corresponding ends of the platform, at least the first and second buttresses together with the respective first and second inner walls and a bottom of the platform defining respective first and second pockets below the platform.

19. The turbine blade of claim 18, wherein a first portion of each of the first and second buttresses are oriented at respective angles of at least 30° with the first and second inner walls, respectively.

20. The turbine blade of claim 18, wherein at least one of the first and second pockets is in fluid communication with a cooling circuit of the turbine blade.
